(19) United States
(12) Patent Application Publication
(10) Pub. No.: US 2025/0134622 A1
(43) Pub. Date: May 1, 2025

(54) COMPRESSED AIR DELIVERY SYSTEM FOR USE IN A MOBILE DENTAL VEHICLE

(71) Applicant: Kare Mobile, Inc., Louisville, KY (US)

(72) Inventor: Kwane Watson, Louisville, KY (US)

(21) Appl. No.: 18/930,294

(22) Filed: Oct. 29, 2024

Related U.S. Application Data
(60) Provisional application No. 63/594,787, filed on Oct. 31, 2023.

(51) Int. Cl. A61C 1/00

(52) U.S. Cl. CPC A61C 1/0084

(57) ABSTRACT

A compressed air delivery system includes a vehicle having a power source, an air compressor configured to be powered by the power source, and a reservoir configured to retain compressed air produced by the air compressor. The vehicle further includes a first outlet disposed on a first side of the vehicle and a second outlet disposed on a second side of the vehicle configured to supply the compressed air in the reservoir to a plurality of tools. The vehicle also includes an operating space having a chair. The first side of the vehicle is disposed opposite the second side of the vehicle.

### CROSS REFERENCE TO RELATED APPLICATIONS

This application claims the benefit of and priority to U.S. Application Ser. No. 63/594,787, filed on Oct. 31, 2023, and entitled “COMPRESSED AIR DELIVERY SYSTEM FOR USE IN A MOBILE DENTAL VEHICLE,” which is incorporated by reference herein in its entirety.

### BACKGROUND

A dental air compressor is a machine that creates high-pressure air that is configured to run handpieces that an oral health expert (e.g., a dentist, a dental hygienist, a dental therapist, a dental assistant, or other dental health professional) uses to repair, maintain, and treat a patient's teeth. Current air compressors used in mobile dental vehicles are loud, expensive, and lack sufficient torque to deliver consistent air pressure to power the handpieces and tools used by the oral dental experts. Thus, there exists a need for consistent quiet compressed air delivery systems for use in mobile dental vehicles.

### SUMMARY

In accordance with some embodiments of the present disclosure, a compressed air delivery system includes a vehicle having a power source, an air compressor configured to be powered by the power source, and a reservoir configured to retain compressed air produced by the air compressor. In some embodiments, the vehicle further includes a first outlet disposed on a first side of the vehicle and a second outlet disposed on a second side of the vehicle, opposite the first side. The first and second outlets are configured to supply the compressed air in the reservoir to a plurality of tools. The first outlet and the second outlet that are disposed on opposite sides of the vehicle can accommodate a preference of a right hand or left hand dominant oral health expert, allowing the oral health expert to perform a dental procedure from a right side or a left side of a dental chair disposed in an operating space.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an example schematic of a mobile dental system according to an embodiment of the present disclosure;

FIG. 2 is a top plan view of an example of a mobile dental vehicle of the mobile dental system of FIG. 1;

FIG. 3 is a top plan view of an example of the mobile dental vehicle of the mobile dental system of FIG. 1;

FIG. 4 illustrates an example compartment of the mobile dental vehicle of the mobile dental system of FIG. 1;

FIG. 5 illustrates an example reservoir of the mobile dental system of FIG. 1;

FIG. 6 is a top plan view of another example of the mobile dental vehicle of the mobile dental system of FIG. 1;

FIG. 7 illustrates another example compartment of the mobile dental vehicle of the mobile dental system of FIG. 1;

FIG. 8 illustrates an example compressor of the mobile dental system of FIG. 1;

FIG. 9 is an example method for operating a mobile dental system in accordance with the present disclosure;

FIG. 10 is another example method for operating a mobile dental system in accordance with the present disclosure;

FIG. 11 is yet another example method for operating a mobile dental system in accordance with the present disclosure; and

FIG. 12 is still another example method for operating a mobile dental system in accordance with the present disclosure.

### DETAILED DESCRIPTION

In accordance with various embodiments, systems for compressing air for a mobile service provider are provided. In some embodiments, mechanisms described herein can be used to quietly and efficiently deliver compressed air to operate handpieces or tools. In some examples, the air compression systems of the disclosure may be applicable to medical or dental goods or a provider of medical or dental services in connection with a mobile health service. However, it should be appreciated that the disclosure may be used for any type of goods or service provider that operates tools and machinery via compressed air.

As noted above, in some contexts, it is useful to generate compressed air for the powering of hand tools in mobile dental vehicles. Mobile dental vehicles allow dental care to be provided to communities and regions that may otherwise not have available dental care and resources. Currently available portable compressed air delivery systems utilized by mobile dental clinics are carted or carried in a suitcase or similar carrying mechanism. Currently available configurations include an air compressor that is fluidly coupled directly to dental tools via a hose, requiring the air compressor to produce consistent high amounts of air pressure and air flow. Such configurations of air compressors often deliver oscillating or inconsistent air flow and pressure to the dental tools causing inconsistent usage properties of the dental tools (e.g., a dental drill may cycle between slow and fast). Inconsistencies in usage properties may increase the difficulty of a dental procedure, while also posing an increased risk to a patient that is receiving treatment. As many currently available air compressors are disposed in an operating space of the mobile dental vehicle, the compressors often generate unwanted levels of noise, increasing communication difficulty between the patient and the dental expert, and between the dental expert and their assistants.

Embodiments of the present invention may address these and other issues, including providing a compressed air delivery system that delivers a more consistent air flow and pressure to the dental tools, while also producing less noise within the operating space of the mobile vehicle. The present disclosure ultimately provides a safer environment for patients and dental experts that receive and deliver dental treatment in mobile dental vehicles.

Embodiments of the present disclosure include a mobile health vehicle having an air compressor and a pressurized reservoir. The air compressor is configured to pressurize the reservoir, and the reservoir is configured to deliver consistent air flow and pressure to a plurality of tools. Including the reservoir in a compressed air delivery system for mobile dental vehicles provides several benefits. The utilization of the reservoir improves functionality and safety of the tools. The reservoir releases a steady and consistent flow of compressed air, providing steady and consistent usage properties of the tools (e.g., a consistent rotations per minute (“rpm”) of a drill). Providing increased consistency of the usage properties of the tools potentially contributes to safer and faster procedures.

Stored compressed air may be available immediately to a user, potentially saving a dental expert time. Finally, the utilization of the reservoir can lead to cleaner air delivery to the tools. For example, the usage of the reservoir may mitigate condensation and contaminants, which may naturally occur in air pressurization systems.

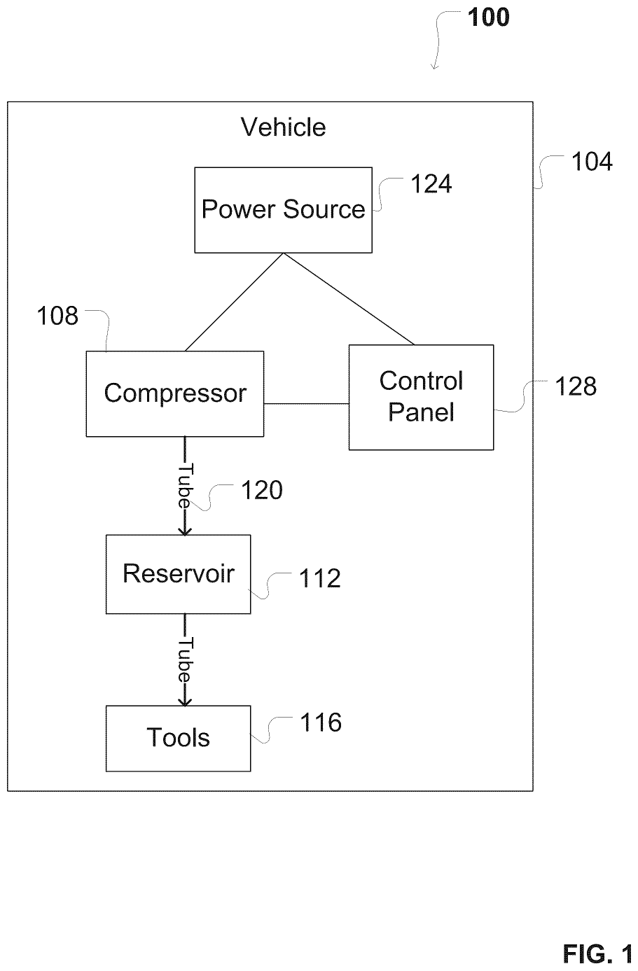

Referring now to the figures, FIG. 1 shows an example schematic of a mobile dental system 100 for a vehicle 104 that is configured to generate, store, and utilize compressed air. As shown in FIG. 1, a compressor 108 is fluidly coupled to a reservoir 112. The compressor 108 is configured to compress and deliver air into the reservoir 112. The reservoir 112 is fluidly coupled to a plurality of tools 116 (e.g., pneumatic tools including drills, air hoses, or other pieces of equipment that may be powered by compressed air). The reservoir 112 is configured to store and selectively deliver the compressed air to the plurality of tools 116. In some embodiments, the compressor 108, the reservoir 112, and the tools 116 are fluidly coupled via a plurality of tubes 120. As discussed further below, the compressor 108, the reservoir 112, and the tools 116 may be disposed at various locations around the vehicle 104.

In some embodiments, the compressor 108 is powered by a power source 124. In some embodiments, the power source 124 is a battery (e.g., a lead-acid battery, a lithium-ion battery, an alkaline battery, etc.). In some embodiments, the power source 124 is a generator or an alternator of the vehicle 104. In some embodiments, the power source 124 provides a voltage to the compressor 108 that is 12V (e.g., a voltage provided by a standard vehicle). The power source 124 may alternatively provide the voltage to the compressor 108 that is 24V. In some embodiments, the compressor 108 may alternatively include a combustible engine fueled via gas, diesel, or propane.

In some embodiments, the compressor 108 is powered “on” and “off” via a control panel 128. The control panel 128 may include a plurality of switches configured to regulate power to pumps, lights, and fans. In some embodiments, the control panel 128 includes physical switches. In some embodiments, the control panel 128 instead includes a graphical user interface having digital switches.

In some embodiments, the compressor 108 is a piston compressor. In other embodiments, the compressor 108 is instead any one of a diaphragm, helical screw, sliding vane, scroll, rotary lobe, centrifugal, or axial type compressor. In some embodiments, the compressor 108 is configured to provide a maximum pressure of about 200 pounds per square inch (“psi”). In some embodiments, the compressor 108 is configured to provide a maximum pressure of between about 150 psi and about 250 psi or about 100 psi and about 300 psi. In some embodiments, the compressor 108 is configured to provide a maximum flow rate of about 3.5 cubic feet per minute (“CFM”). In some embodiments, the compressor 108 is configured to provide a maximum flow rate of between about 3 CFM and about 4 CFM or about 2.5 CFM and about 4.5 CFM.

As described above, the compressor 108 is configured to compress and deliver air to the reservoir 112, via the tubes 120. In some embodiments, the compressor 108 is configured to pressurize the reservoir 112 to a pressure of 200 psi. In some embodiments, the compressor 108 may alternatively pressurize the reservoir 112 to a pressure of between about 150 psi and about 250 psi, or about 100 psi and about 300 psi.

As described above, the reservoir 112 stores pressurized air. In some embodiments, the reservoir 112 is configured to regulate flow and pressure of the compressed air to the plurality of tools 116. In some embodiments, the reservoir 112 is configured to deliver the compressed air to the tools 116 at a pressure of about 50 psi. In some embodiments, the reservoir 112 is configured to deliver the compressed air to the tools 116 at a pressure of between about 45 psi and 55 psi or about 40 psi and about 50 psi. As the reservoir is configured to deliver compressed air to the tools 116 at a pressure that is lower than a pressure of the compressed air stored in the reservoir 112, the reservoir 112 is able to deliver the compressed air to the tools 116 at a consistent air pressure and air flow.

As described above, the compressor 108 is configured to compress air into the reservoir 112, and the reservoir 112 is configured to provide consistent regulated air flow to the plurality of tools 116 during a procedure. In some embodiments, the compressor 108 is configured to deliver compressed air to the reservoir 112 throughout a procedure. For example, the compressor 108 may be configured to deliver compressed air to the reservoir 112 as the reservoir 112 is delivering air to the tools 116.

In some embodiments, the reservoir 112 is configured to provide air to the tools 116 independent of the compressor 108. For example, the compressor 108 may not deliver compressed air to the reservoir 112, while the reservoir 112 is delivering air to the tools 116. In such examples, the compressor 108 may not be powered on and may not generate noise, advantageously providing a quieter more relaxing environment for the dental expert and the patient during procedures. In some embodiments, the compressor 108 may be configured to deliver the compressed air to the reservoir 112, when the pressure in the reservoir 112 drops below a specified pressure (e.g., the pressure in the reservoir drops below 100 psi).

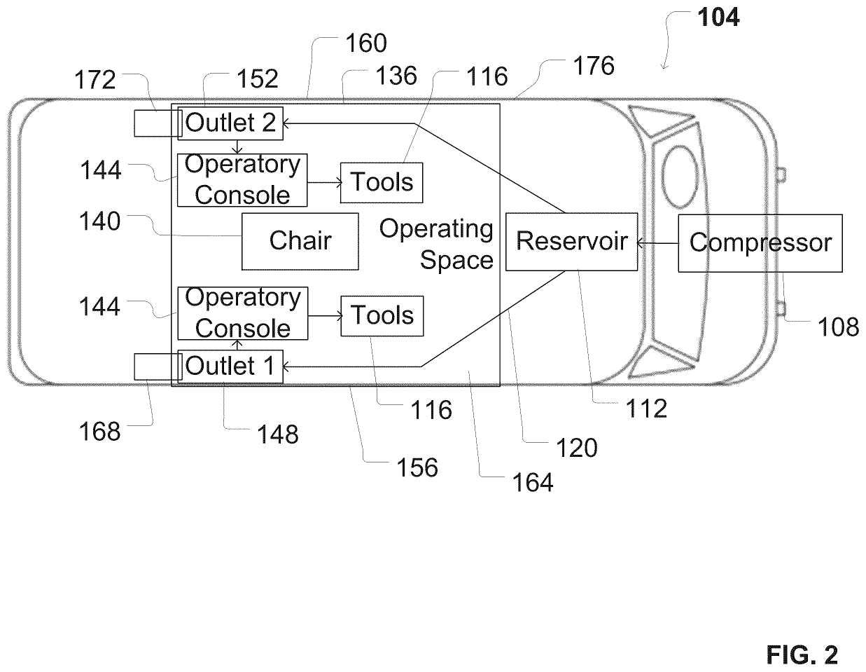

Referring to FIG. 2, the vehicle 104 includes an operating space 136. In some embodiments, the operating space 136 is a portion of the vehicle 104 utilized during dental procedures (e.g., teeth cleanings, root canals, and other teeth maintenance and repair procedures, etc.). For example, the operating space 136 may include a dental chair or bed 140 configured to receive and retain a patient. In some embodiments, the dental chair 140 is disposed at a center of the operating space 136. In such configurations, the dental experts may operate from any location around the dental chair 140 depending on the preference of the dental expert.

In some embodiments, the reservoir 112 is configured to deliver compressed air to an operatory console 144, located within the operating space 136. In some embodiments, the operatory console 144 is configured to house the tools 116. In some embodiments, the operatory console 144 is fluidly coupled to the reservoir 112. In some embodiments, the compressed air may be delivered to the tools 116 via the operatory console 144.

Still referring to FIG. 2, the reservoir 112 is configured to deliver compressed air via a first outlet 148 and/or a second outlet 152. In some embodiments, the reservoir 112 may be fluidly coupled to the first and second outlet 148, 152 through the tubes 120. In some embodiments, the first outlet 148 and the second outlet are disposed within the operating space 136. In some embodiments, the first outlet 148 and the second outlet 152 are disposed on opposite sides of the vehicle 104. For example, the first outlet 148 can be disposed on a first side or passenger side 156 of the vehicle 104 while the second outlet 152 can be disposed on a second side or driver side 160 of the vehicle 104. The opposing configuration of the first outlet 148 and the second outlet 152 allows the operatory console 144, and therefore the tools 116, to be placed on either side of the operating space 136, depending on the preference of the dental expert. For example, a right-handed dental expert may prefer to operate on a different side of the operating space 136 as compared to a left-handed dental expert.

In some embodiments, the first outlet 148 and the second outlet 152 include standardized male adapters. The first and second outlet 148, 152 may advantageously couple to any type of the operatory console 144, allowing dental experts to utilize existing equipment, reducing the need to purchase specialized adapters or operatory consoles. The flexibility of the first and second outlets 148, 152 to supply compressed air to multiple types of the operatory console 144 may further allow dental experts to utilize their preferred type or brand of the operatory console 144 and tools 116. Such configurations may be advantageous over currently available portable dental air delivery systems that may be configured to operate a single brand or type of the operatory console 144 or the tools 116.

In some embodiments, it is advantageous to dispose the first outlet 148 and the second outlet 152 near a floor 164 of the vehicle 104 (e.g., less than two or three feet from the floor 164). For example, the tubes 120 connected to the first and second outlet 148, 152 disposed near the floor 164, may be easier to step over for the dental experts. In some embodiments, as illustrated in FIG. 2, the first outlet 148 is disposed on a first tire well 168, and the second outlet 152 is disposed on a second tire well 172. The first and second tire wells 168, 172 may be disposed over rear tires of the vehicle 104. Although the illustration of FIG. 2 depicts the first outlet 148 and the second outlet 152 as being disposed on the first and second tire well 168, 172, the first outlet 148 and the second outlet 152 may alternatively be disposed anywhere within the vehicle 104. For example, the first outlet 148 and the second outlet 152, may alternatively be disposed on one or more sidewalls 176 of the vehicle 104.

Although the illustration of FIG. 2 depicts the reservoir 112 as being disposed near a front of the vehicle 104, the reservoir 112 may alternatively be disposed anywhere within or on the vehicle 104. For example, the reservoir 112 may alternatively be disposed in a rear of the vehicle 104, or on an exterior of the vehicle 104. Although the illustration of FIG. 2 depicts the compressor 108 as being disposed near a front of the vehicle 104, the compressor 108 may alternatively be disposed anywhere within or on the vehicle 104. For example, the compressor 108 may alternatively be disposed in a rear of the vehicle 104, or on an exterior of the vehicle 104.

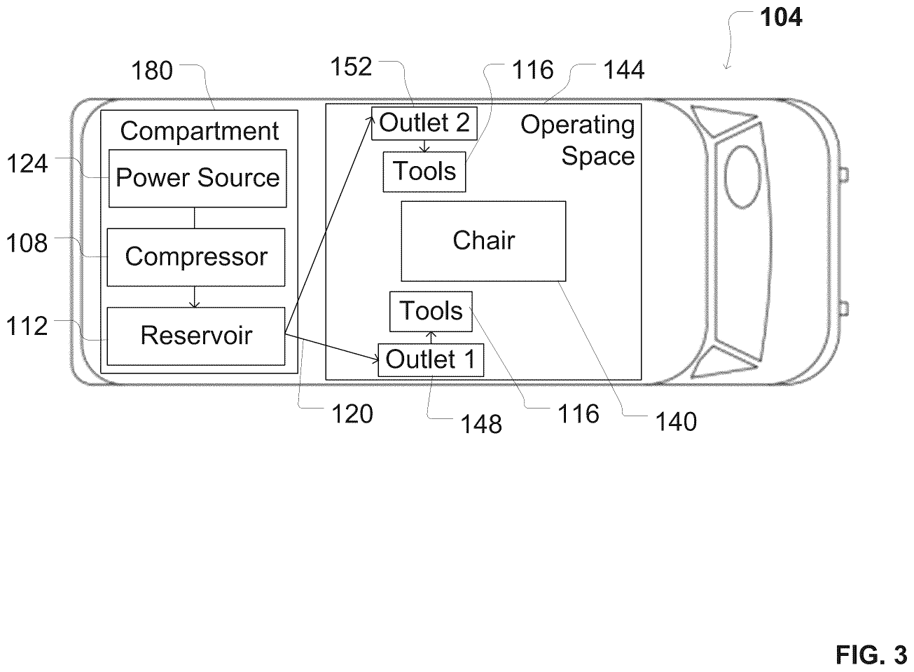

As illustrated in FIGS. 3-5, in some examples, the compressor 108, the reservoir 112, and the power source 124 are disposed in a first compartment 180. In some embodiments, the first compartment 180 is disposed in a rear of the vehicle 104. In some embodiments, the first compartment 180 is a noise reduction compartment. In some embodiments, the first compartment 180 is configured to prevent noise created by the compressor 108 from infiltrating the operating space 136. Mitigating noise in the operating space 136 may provide a quieter more relaxing environment for the dental expert and the patient during procedures.

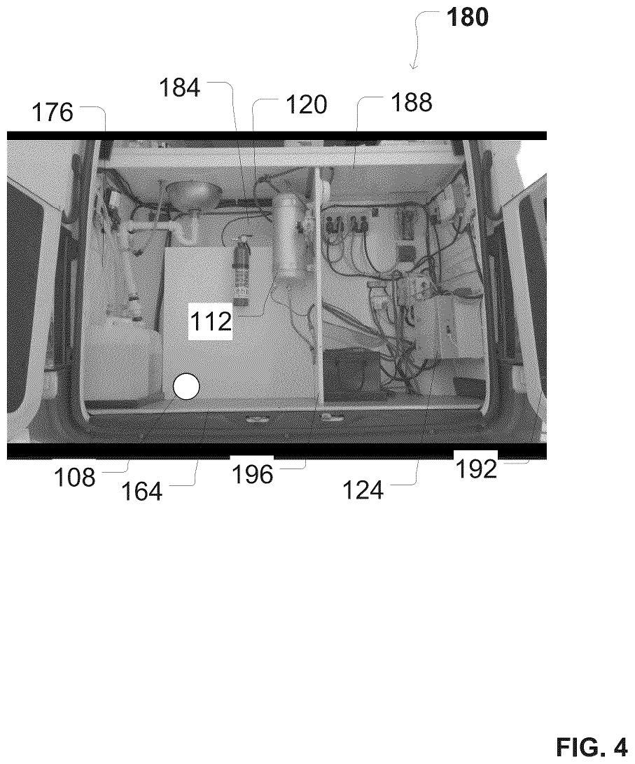

Referring to FIG. 4, in some embodiments, the first compartment 180 is defined by a front wall 184, a ceiling 188, the sidewalls 176, the floor 164, and a trunk door 192 of the vehicle 104. In some embodiments, the front wall 184 separates the first compartment 180 from the operating space 136. In some embodiments, the ceiling 188 of the first compartment 180, is configured as a countertop for the operating space 136. In such configurations, the ceiling 188 also separates the first compartment 180 from the operating space 136.

In some embodiments, the front wall 184 and the ceiling 188 include a noise dampening material. For example, the front wall 184 and the ceiling 188 can be made of a thickened plastic, or can be lined with a foam configured to reduce noise transmission from the first compartment 180 to the operating space 136. In some embodiments, the sidewalls 176 and/or the floor 164 can also be lined with a sound dampening material to limit the propagation of noise. Similar to the front wall 184 and the ceiling, the sidewalls 176 can also be made of a thickened plastic or lined with foam. In some embodiments, the floor 164 may include a rug, foam flooring, or other textured surface to assist in the absorption of noise. Other examples of effective soundproofing materials that may line an inside of the first compartment 180 include but are not limited to cotton, plastics, felt, sponges, denim, fiberglass, mineral wool, rubber, metal alloys, or a rubber matt coupled to a metal alloy similar to Dynamat™M.

In some embodiments, the front wall 184 is a false wall. For example, there may be an interstitial space between the front wall 184 and a wall (not shown) behind the front wall 184, between the front wall 184 and the operating space 136. In some embodiments, the interstitial space can be filled with a sound proofing material, such as foam, cardboard, plastic, or rubber to reduce noise penetration into the operating space 136. Similar to the front wall 136, the ceiling 188 can be a false ceiling. For example, a second interstitial space filled with sound proofing material may be disposed between the ceiling 188 and the countertop of the operating space 136. In some embodiments, the interstitial space and/or the second interstitial space do not include a filling.

In some embodiments, the front wall 184, the sidewalls 176, the floor 164 and/or the ceiling 188 can be textured. The texture covering the front wall 184, the sidewalls 176, the floor 164 and/or the ceiling 188 may absorb excess noise. In some embodiments, the texture of the front wall 184, the sidewalls 176, the floor 164 and/or the ceiling 188 may instead reflect the noise away from operating space 136.

In some embodiments, the sidewalls 176, the front wall 184, the floor 164, and the ceiling 188 may be joined at junctions. For example, the front wall 184 is joined with the sidewalls 176 at two or more junctions. Similarly, the front wall 184 is joined with the floor 164 and the ceiling 188 at two distinct junctions. In some embodiments, each of the junctions separating two or more of the sidewalls 176, the front wall 184, the floor 164, and the ceiling 188 include a gasket or seal. The gaskets may be made of a plastic or rubber, and are configured to fill any potential gaps that exist at the junctions. The gaskets can reduce the penetration of noise into the operating space through the potential gaps that exist at the junctions. Advantageously, the gaskets may seal the first compartment 180 from liquid penetration, potentially further protecting any electrical components disposed within the first compartment 180. In some embodiments, the junctions can instead be sealed with a caulk or any other type of sealant that is applied as a liquid, semi-solid, or paste. In some embodiments, the caulk is specifically an acoustical caulk.

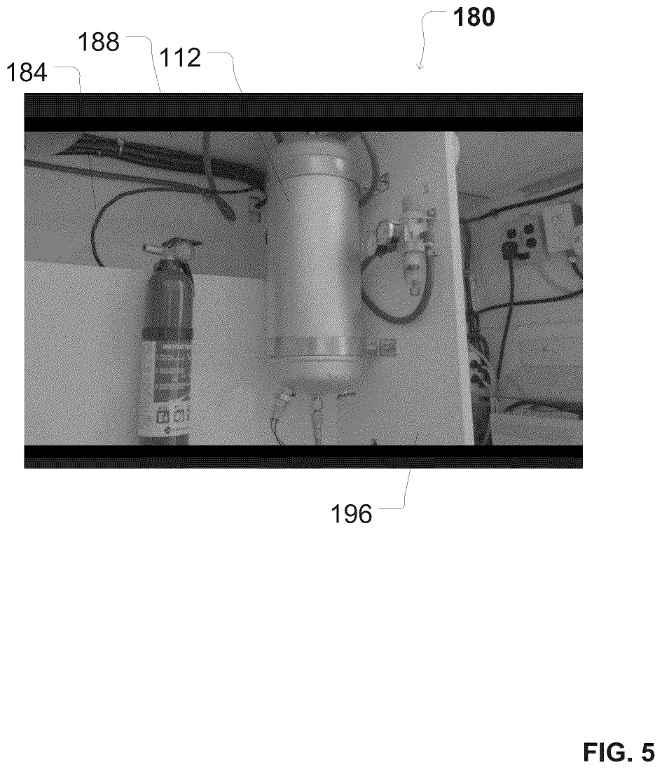

As illustrated in FIGS. 4 and 5, the reservoir 112 can be mounted on an interior wall 196 within the first compartment 180. In some embodiments, the reservoir 112 can alternatively be mounted to the floor 164 of the vehicle 104 or to the ceiling 188 of the first compartment 180.

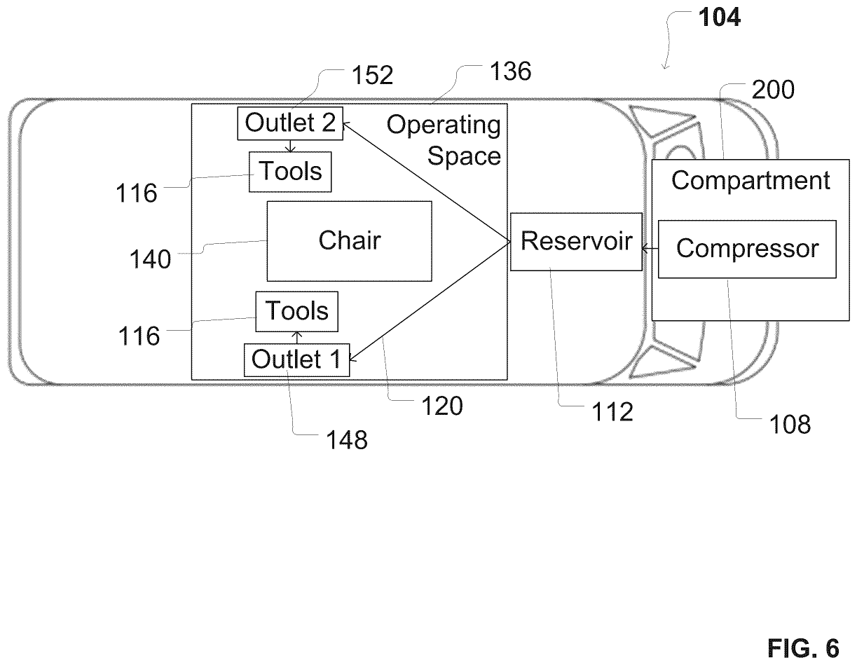

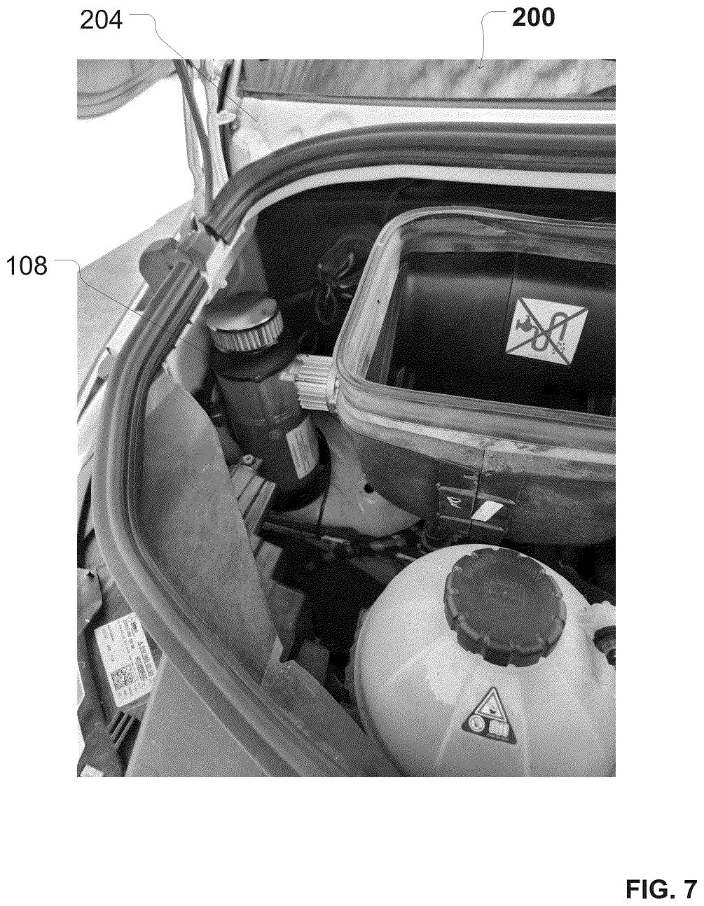

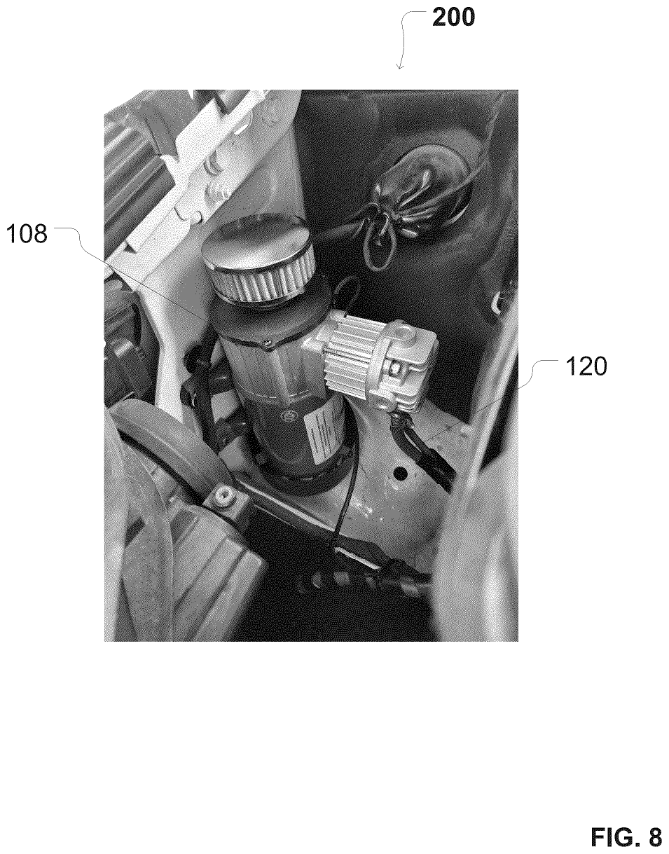

As illustrated in FIGS. 6-8, in some examples, the compressor 108 is alternatively disposed in a second compartment 200. In some embodiments, the second compartment 200 is disposed on an exterior 204 of the vehicle 104. For example, as illustrated in FIGS. 7 and 8, the second compartment 200 can be the engine compartment. Disposing the compressor 108 on the exterior 204 of the vehicle 104 may help to prevent noise created by the compressor 108 from infiltrating the operating space 136. In some embodiments, the compressor 108 is alternatively configured to be disposed elsewhere on the exterior 204 of the vehicle 104. For example, the compressor 108 may be mounted to a roof or a hitch of the vehicle 104. In such embodiments, the reservoir 112 can be disposed anywhere within or on the vehicle 104.

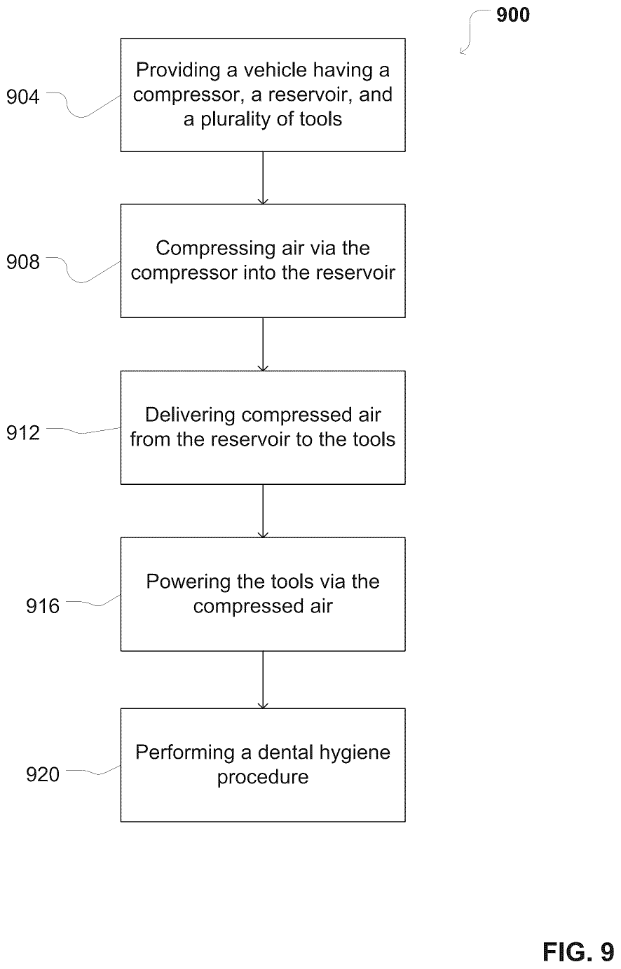

Referring now to FIG. 9, a method 900 is illustrated for utilizing a compressed air system for a mobile dental vehicle, which may include fewer or more steps than depicted. In some embodiments, the following steps are performed in any order. At a first step 904, the method 900 includes providing a vehicle having a compressor, a reservoir, and a plurality of tools. At a second step 908, the method 900 includes compressing air via the compressor into the reservoir. At a third step 912, the method 900 includes delivering compressed air from the reservoir to the tools. At a fourth step 916, the method 900 includes powering the tools via the compressed air. At a fifth step 920, the method 900 includes performing a dental procedure.

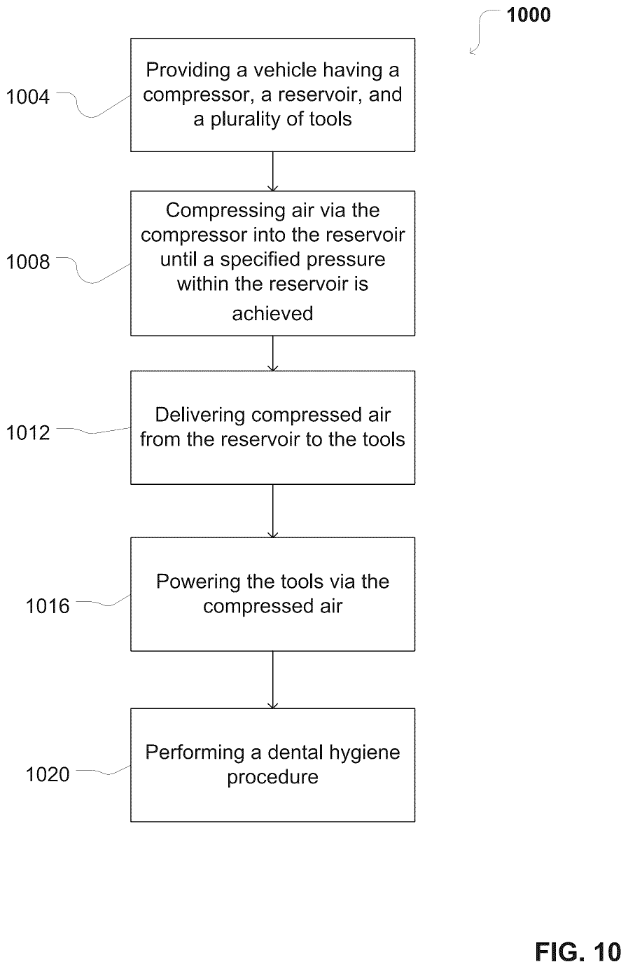

Referring now to FIG. 10, a method 1000 is illustrated for utilizing a compressed air system for a mobile dental vehicle, which may include fewer or more steps than depicted. In some embodiments, the following steps are performed in any order. At a first step 1004, the method 1000 includes providing a vehicle having a compressor, a reservoir, and a plurality of tools. At a second step 1008, the method 1000 includes compressing air via the compressor into the reservoir until a specified pressure within the reservoir is achieved. At a third step 1012, the method 1000 includes delivering compressed air from the reservoir to the tools. At a fourth step 1016, the method 1000 includes powering the tools via the compressed air. At a fifth step 1020, the method 1000 includes performing a dental procedure.

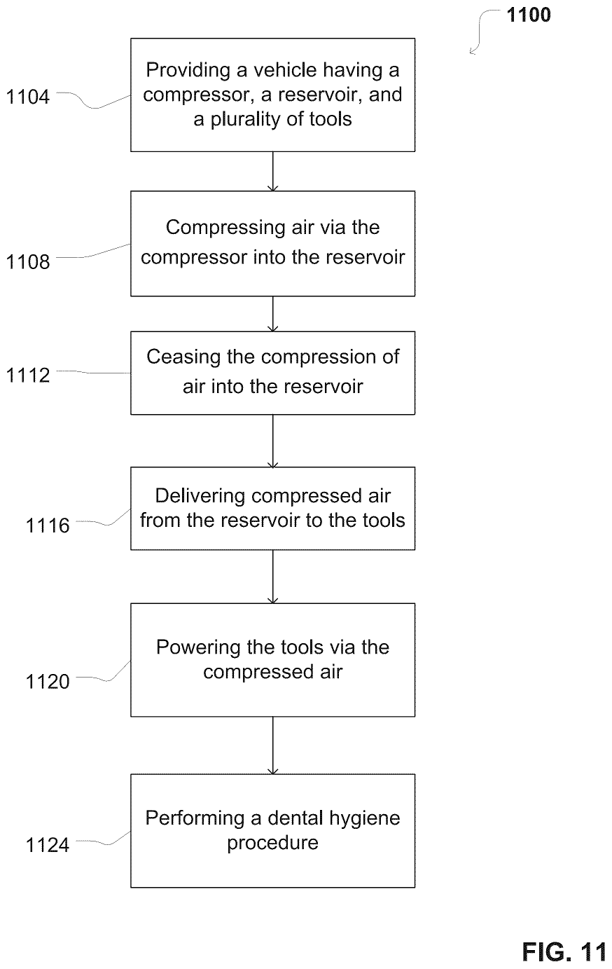

Referring now to FIG. 11, a method 1100 is illustrated for utilizing a compressed air system for a mobile dental vehicle, which may include fewer or more steps than depicted. In some embodiments, the following steps are performed in any order. At a first step 1104, the method 1100 includes providing a vehicle having a compressor, a reservoir, and a plurality of tools. At a second step 1108, the method 1100 includes compressing air via the compressor into the reservoir. At a third step 1112, the method 1100 includes ceasing the compression of air into the reservoir. At a fourth step 1116, the method 1100 includes delivering compressed air from the reservoir to the tools. At a fifth step 1120, the method 1100 includes powering the tools via the compressed air. At a sixth step 1124, the method 1100 includes performing a dental procedure.

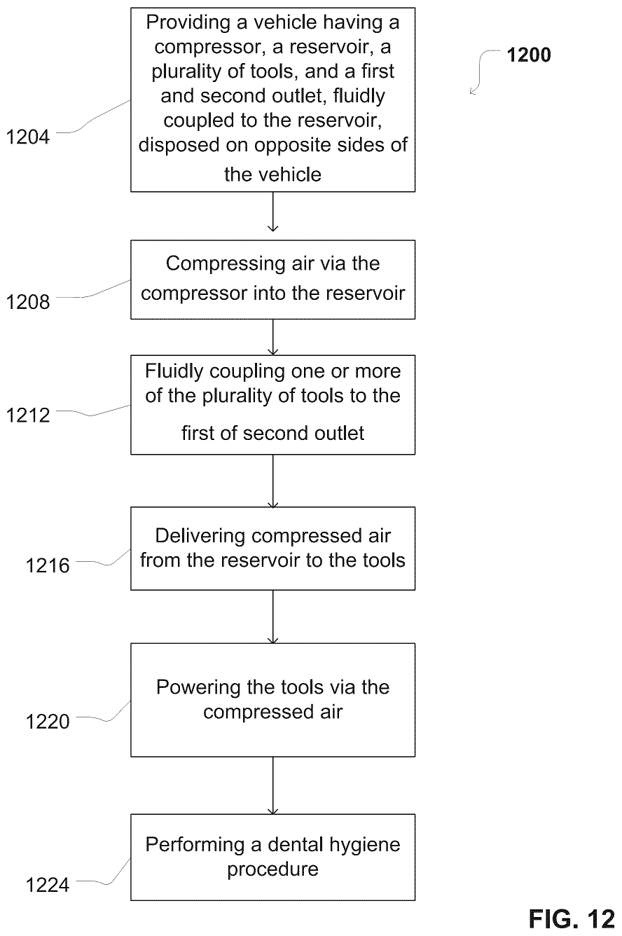

Referring now to FIG. 12, a method 1200 is illustrated for utilizing a compressed air system for a mobile dental vehicle, which may include fewer or more steps than depicted. In some embodiments, the following steps are performed in any order. At a first step 1204, the method 1200 includes providing a vehicle having a compressor, a reservoir, a plurality of tools, and a first and second outlet, fluidly coupled to the reservoir, disposed on opposite sides of the vehicle. At a second step 1208, the method 1200 includes compressing air via the compressor into the reservoir. At a third step 1212, the method 1200 includes fluidly coupling one or more of the plurality of tools to the first or second outlet. At a fourth step 1216, the method 1200 includes releasing compressed air from the reservoir to the tools. At a fifth step 1220, the method 1200 includes powering the tools via the compressed air. At a sixth step 1224, the method 1200 includes performing a dental procedure.

As used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

As used herein, the term “vehicle” refers to a sprinter van, a recreational vehicle, a bus, or any other type of vehicle that may be used for a mobile dental clinic, or other mobile health clinic.

Unless otherwise limited or defined, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive. Ranges as provide herein are inclusive of endpoints unless otherwise specified.

As used in the figures, an arrow may indicate a mechanical coupling via tubing, while a line may indicate electrical coupling.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A compressed air delivery system, the system comprising:
a vehicle, the vehicle including:
a power source;
an air compressor configured to be powered by the power source;
a reservoir configured to retain compressed air produced by the air compressor;
a first outlet disposed on a first side of the vehicle and a second outlet disposed on a second side of the vehicle configured to supply the compressed air in the reservoir to a plurality of tools; and
an operating space, the operating space including:
a chair,
wherein the first side of the vehicle is opposite the second side of the vehicle.

2. The system of claim 1, wherein the plurality of tools are pneumatic dental tools.

3. The system of claim 1, wherein the air compressor is disposed in a compartment.

4. The system of claim 3, wherein the compartment is soundproofed.

5. The system of claim 3, the compartment is disposed on an exterior of the vehicle.

6. The system of claim 1, wherein the power source is a battery.

7. The system of claim 1, wherein the reservoir is configured to release compressed air to the first and second outlets at a pressure of about 50 psi.

8. The system of claim 1, wherein an operatory console configured to house the tools is coupled to the first outlet or the second outlet.
